(19) United States
(12) Patent Application Publication
(10) Pub. No.: US 2010/0072045 A1
(43) Pub. Date: Mar. 25, 2010

(54) Switch Pole with a Mounting Frame Having Latching Means

(75) Inventors: Karsten Freundt, Falkensee (DE); Ralph Löser, Birkenstein (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/063,513

(22) PCT Filed: Aug. 10, 2005
(86) PCT No.: PCT/DE2005/001435

§ 371 Date: Mar. 4, 2008

(51) Int. Cl. H01H 9/02

(52) U.S. Cl. 200/293

(57) ABSTRACT

A switch pole for interrupting an alternating electrical current has a supporting frame formed of insulating material. An interrupter extends in a longitudinal direction within the supporting frame between an input connection and an output connection and is configured to interrupt the alternating current between the input connection and the output connection. The input connection, the output connection, and the interrupter are held by the supporting frame. The insulating capacity of the supporting frame of the novel switch pole can be matched in a simple manner to the requirements placed respectively on the switch pole. For that purpose, the supporting frame has latching means for accommodating additional insulating parts, with which the insulating capacity of the supporting frame is increased.

The invention relates to a switch pole for interruption of an electrical alternating current having a mounting frame, which is manufactured from a dielectric material, and having a switching tube which extends in a longitudinal direction within the mounting frame between an input connection and an output connection and is designed to interrupt the alternating current between the input connection and the output connection with the input connection, the output connection and the switching tube being held by the mounting frame.

A switch pole such as this is already known from US 2001/0025829 A1. The switch pole disclosed there has a mounting frame which is manufactured from a dielectric material and is designed to hold a vacuum interrupter tube which extends in a longitudinal direction between an input connection and an output connection. The mounting frame is designed to hold said connecting pieces and the vacuum interrupter tube, which is at a high-voltage potential during operation, in an isolated form. The already known switch pole is subject to the disadvantage that the mounting frame has only a restricted isolation capability for the generally high electrical fields during operation, so that complex additional measures must be provided for the components to which high voltage is applied.

The invention is based on the object of providing a switch pole of the type mentioned initially, which has a mounting frame whose isolation capability can be matched in a simple manner to the respective requirements placed on the switch pole.

The invention achieves this object in that the mounting frame has latching means for holding additional isolating parts, by means of which the isolation capability of the mounting frame is increased.

Within the scope of the invention, the mounting frame has latching means. The latching means are used to hold additional isolating parts which, for example, extend like walls on the mounting frame. The additional isolating parts are manufactured from an insulating material, for example an insulating plastic, and carry out additional isolating functions on the mounting frame. Within the scope of the invention, it is therefore possible to increase the isolation capability of the entire mounting frame in a simple manner and at low cost simply by insertion of the additional isolating parts into the latching means of the mounting frame. The switch pole according to the invention can therefore be matched by simple measures to the respective requirements which apply of the desired installation location. For example, it is possible within the scope of the invention to increase the operating parameters such as the operating voltage, with the additional isolation that is required in this case because of the high electrical fields that occur being provided by the additional isolating parts inserted into the latching means.

The mounting frame is advantageously composed of a mechanically dimensionally stable plastic, and the additional parts are composed of an elastically deformable plastic. For example, the mounting frame is composed of a thermosetting plastic, and the additional isolating parts are composed of a thermoplastic. According to this advantageous further development, only the mounting frame carries out the mechanical supporting function for the components of the switching tube which are mounted in it, while the additional isolating parts just have an isolating effect, because of their elasticity. Because of the elasticity of the additional isolating parts, they can be inserted particularly easily into the latching means of the mounting frame, with the elasticity allowing additional retention, for example by creating a force fit.

The additional isolating parts which are held in the latching means advantageously form a labyrinth structure with the latching means. The labyrinth structure increases the electrical withstand capability of the connecting areas in the joints bounded by the isolating part and the mounting frame. Furthermore, if the additional isolating part is also elastic, this results in even better contact between the isolating part and the mounting frame, so that the electrical withstand capability is also improved by this characteristic. The labyrinth structure increases the creepage current distance from a component to which high-voltage potential is applied to a surface which is at ground potential.

The latching means are advantageously in the form of latching grooves. In this case, the additional isolating parts have a wall thickness which corresponds approximately to the internal distance between the latching grooves, thus allowing the additional isolating parts to be inserted into the latching grooves and at the same time providing retention for the additional isolating parts in the latching grooves. In contrast to this, it is likewise possible within the scope of the invention for the additional isolating parts to be bent elastically into the latching grooves during insertion, and to provide retention for the additional isolating parts, just for this reason. The latching grooves are, for example, formed at expedient points on the mounting frame. In contrast to this, the latching grooves on individual mounting frame components run over a longer distance.

The frame advantageously has two side walls, with the latching means extending in the longitudinal direction on the side walls. By way of example, the side walls are formed parallel to one another, with lateral webs or attachment webs which extend in the lateral direction between the side walls providing the necessary mechanical retention for the switch pole. The wall-like configuration of the mounting frame has the advantage that the mounting frame provides a housing-like shielding effect on two mutually opposite sides, with two sides of the mounting frame, which are likewise mutually opposite, being open and not covered. Within the scope of the invention, it is possible with the aid of the latching means to provide the sides of the mounting frame which are not shielded or covered with additional isolating parts, which are likewise in the form of walls, thus resulting overall in a closed housing around the components to which high-voltage potential is applied.

The additional isolating parts expediently have a cross section with a U-profile, at least in places. A U-profile has been found to be particularly advantageous for latching the additional isolating parts to the latching means since an elastic restoring force is produced by the free limbs of the U-profile being bent towards one another, and this can be used to secure the additional isolating components. Furthermore, the end face of the free limbs can easily be inserted into the latching means.

In one preferred exemplary embodiment, the free limbs of the U-profile are thus inserted, in the installed state, at the end into latching grooves in the mounting frame. The wall thickness of the free limbs expediently corresponds approximately to the internal diameter of the latching grooves, as has already been stated.

The end wall thickness of the free limbs of the U-profile is advantageously only slightly larger than the diameter of the latching grooves, so that the free limbs are slightly elastically deformed during insertion, in this way producing a retaining force.

In contrast to this, it is possible within the scope of the invention for the free limbs of the U-profile to rest at the end, in the installed state, on stop shoulders which are formed in the side walls, with their outer faces being pressed against the inner faces of the side walls, thus producing a force fit between the additional isolating part and the mounting frame. According to this refinement of the invention, the restoring forces are made use of which result when the free limbs of the U-profile are moved towards one another beyond their equilibrium position and in this position rest on the inner walls of the mounting frame. The restoring force then produces a force fit, which is sufficient to hold the additional isolating components. The stop shoulders are used only for accurate alignment of the additional isolating parts on the mounting frame.

The additional isolating parts advantageously have tubular connecting stubs at least in places which, in the installed state, extend from the input connection and/or the output connection. The tubular connecting stubs make it possible to pass conductor connections to the input connection or to the output connection, with the tubular connecting stubs producing additional isolation in the connecting area between the conductors connected to them and the connecting pieces, without having to touch the electrical conductor in the process. This even further enhances the isolating capability of the switch pole and of the mounting frame.

Further, more expedient refinements and advantages of the invention are the subject matter of the following description of exemplary embodiments of the invention with reference to the drawing, with components that have the same effect being provided with the same reference symbols, and in which:

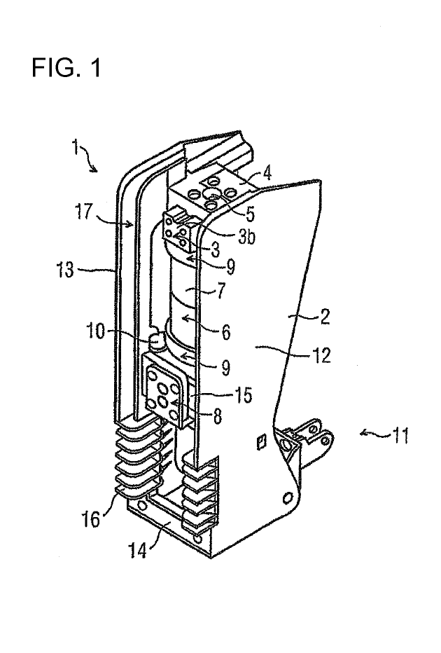

FIG. 1 shows a perspective illustration of one exemplary embodiment of the switch pole according to the invention with a mounting frame without additional isolating parts,

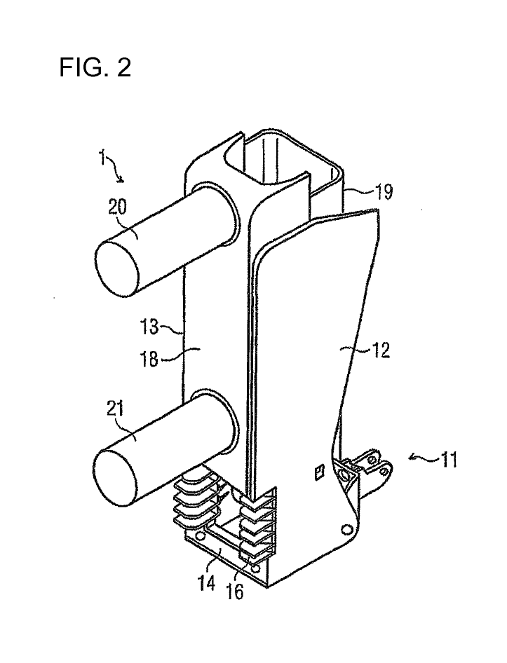

FIG. 2 shows the switch pole shown in FIG. 1 with additional isolating parts inserted,

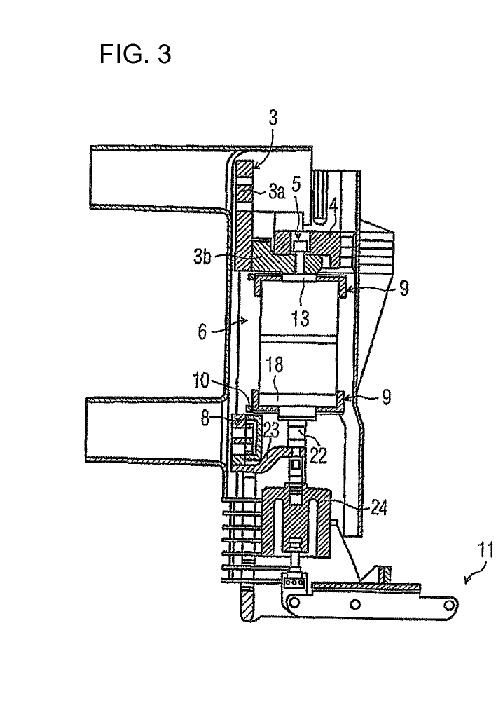

FIG. 3 shows a cross-sectional view of the switch pole shown in FIG. 1,

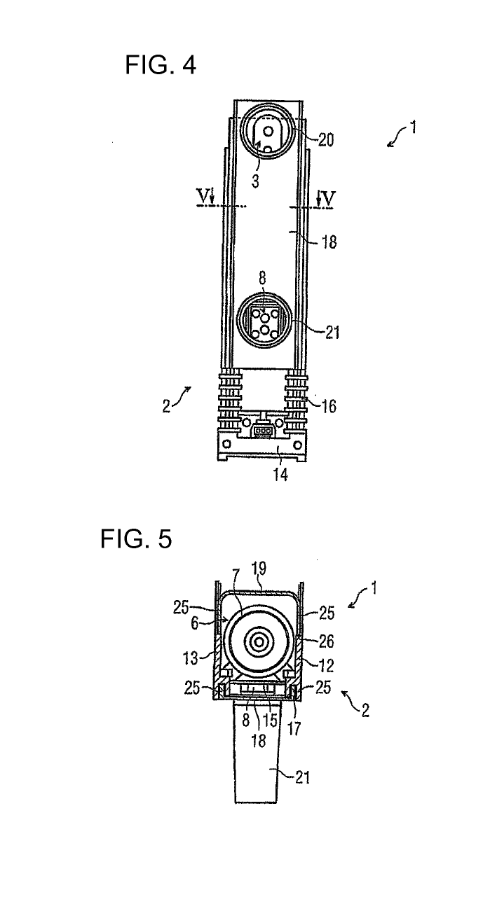

FIG. 4 shows a front view of the switch pole shown in FIG. 2, and

FIG. 5 shows a section view along the line V-V of the switch pole shown in FIG. 4.

FIG. 1 shows a perspective illustration of a first exemplary embodiment of a switch pole 1 according to the invention. The switch pole 1 has a mechanically firm mounting frame 2 to which a pole head section 3b of an input connection 3 is attached. An attachment web 4, which extends in the lateral direction and has attachment holes for the pole head section 3b to be screwed to is used for this purpose. The attachment web 4 also has an aperture opening 5 through which a vacuum interrupter tube 6 can be screwed tightly, as the switching tube, to the pole head section 3b of the input connection 3. The vacuum interrupter tube 6 comprises a hollow cylindrical ceramic housing 7 which is composed of two parts which are connected to one another in the center, with the interposition of an intermediate flange. On the end faces, the ceramic housing 7 is closed by metallic covers, which cannot be seen in FIG. 1, thus forming a vacuum-tight housing. On the upper face of the vacuum interrupter tube 6, in FIG. 1, a fixed contact bolt projects through the upper metallic cover, with a fixed contact piece being held fixed in position on the free side of the fixed contact bolt that is arranged in the vacuum housing. A moving contact piece, which is guided such that it can move longitudinally, is provided opposite the fixed contact piece and is held by means of a switching rod such that it can move. The switching rod passes through a metallic cover facing an output connection 8, with a metal bellows ensuring axial freedom of movement for the switching rod. A holding apparatus 9 is in each case provided in order to hold the vacuum interrupter tube 6 both on its side facing the attachment web 4 and on its side facing away from the attachment web 4. In this case, each of the holding apparatuses 9 have a mounting frame attachment 10, by means of which the respective holding apparatus 9 is anchored firmly on the mounting frame 2. The holding apparatus 9 is also equipped with field control elements, thus allowing the electrical field to be terminated. Each holding apparatus 9 expediently has a flat metallic holding section, on which the respective end face of the vacuum interrupter tube 6 rests. In this case, the vacuum interrupter tube 6 is conductively connected to the holding section. The holding section is surrounded by a flange section which extends at least in places at right angles to the holding section in the direction of the vacuum interrupter tube 6. In this case, the internal diameter of the flange section is somewhat larger than the external diameter of the end area of the vacuum interrupter tube 6 which rests on the holding section. The flange section therefore at least partially surrounds the end face of the vacuum interrupter tube 6, thus preventing the vacuum interrupter tube 6 from sliding off the holding apparatus 9. The flange section is conductively connected to the holding section and has a rounded shape, thus allowing field termination. The flange section is advantageously surrounded by thin-walled, non-conductive plastic insulation.

In order to drive the moving contact piece, the switching rod can be connected via an expedient lever mechanism 11 to a drive which produces the kinetic energy required for switching.

The mounting frame 2, which is formed integrally in the illustrated exemplary embodiment, therefore has two side walls 12, 13 which run essentially parallel to one another. The side walls 12, 13 are connected to one another via the attachment web 4 and, in the lower area, by the bottom web 14. A lateral web 15 is provided for attachment of the output connection 8 and its flat face is aligned towards the front face of the switch pole 1, from which it is accessible from the output connection 8. Outer ribs 16 are arranged between the lateral web 15 and the bottom web 14, increasing the creepage distance for a current on its way from the output connecting piece 8 to a point which is at ground potential.

For attachment of additional isolating parts, which are not shown in FIG. 1, each of the side walls 12 and 13 has latching grooves 17, which extend on the end face of each side wall 13 and 12 of the mounting frame 2 in its longitudinal direction, that is to say upwards. Furthermore, stop shoulders are provided, which cannot be seen in FIG. 1, but which will be described in more detail in the following text.

FIG. 2 shows the exemplary embodiment from FIG. 1 with additional isolating parts 18 and 19 pushed into the latching grooves 17 and onto the stop shoulders. The additional isolating part 19 is intended for shielding of the rear area of the switch pole 1, with the additional isolating part 18 being inserted into the latching grooves 17 in the front area. The additional isolating parts 18 and 19 have a cross section with a U-profile, in which, as can be seen, the free limbs of the U-profile extend well into the retaining grooves 17, thus forming a labyrinth structure which considerably increases the creepage distance. Furthermore, the front additional isolating part 18 has a tubular connecting stub 20 which opens immediately in front of the input connection into the shielding wall area of the additional isolating part 18, so that the connecting area between the input connection and a conductor inserted into the tubular connecting stub 20 is electrically isolated. A corresponding situation applies to the tubular connecting stub 21 which opens at the same height as the output connection into the shielding wall section of the additional isolating part 18.

FIG. 3 shows a cross-sectional view of the switch pole from FIG. 2. This shows particularly clearly that the input connection 3 and the output connection 8 are arranged at the same height as the respective connecting stub 20 or 21. The figure also shows that a switching rod 22, which is guided such that it can move in the longitudinal direction, passes through the lower end face of the vacuum interrupter tube 6, with the switching rod 22 being connected to the output connection 8 via a flexible connecting strip 23. A pot-type isolator 24 is provided in order to isolate the lever mechanism 11, which is at ground potential, from the switching rod 22 which is at high-voltage potential, which pot-type isolator 24 is very well known per se to those skilled in the art, so that its configuration and method of operation do not need to be described in detail at this point. As can also be seen, the vacuum interrupter tube 6 is attached directly to the input connection 3 through the aperture opening 5 in the attachment web 4. As can also be seen in the illustrated cross-sectional view, the input connection 3 has a longitudinal section 3a in addition to the pole-head section 3b, with the pole-head section 3b being screwed to the attachment web 4. The distance between the connecting area of the input connection 3 and the connecting area of the output connection 8, in other words the gap width of the switch pole, can be determined via the length of the longitudinal section 3a. The end face of the vacuum interrupter tube 6 facing the pole-head section 3b is once again surrounded by the flange section of a holding apparatus 9, which is designed to center the vacuum interrupter tube 6 and for field termination.

FIG. 4 shows a front view of the switch pole from FIG. 3, in which the input connection 3 and the output connection 8 can be seen through the tubular connecting stubs 20 and 21, respectively.

FIG. 5 shows the switch pole 1 from FIG. 4 in a view sectioned along the line V, showing the position of the ceramic housing 7 of the vacuum interrupter tube 6. The figure also shows how the free limbs 25 of the isolating part 18, which has a U-profiled cross-section, project into the latching grooves 17 in the mounting frame 2. In this case, the free limbs 25 are spread outwards, so that the restoring force of the free limbs 25 produces a force fit for the isolating part 18 in the mounting frame 2. Furthermore, stop shoulders 26 can be seen on the respective side wall 12 and 13 of the mounting frame 2, on the ends of which the free limbs 25 of the isolating part 19 rest, with the free limbs 25 of the additional isolating part 19, which has a U-profiled cross section, being pressed together beyond their equilibrium position, so that the isolating part 19 is also held on the mounting frame 2 by the restoring force of the free limbs 25.

1-9. (canceled)

10. A switch pole for interrupting an electrical alternating current, comprising:
a mounting frame formed of an insulating material, said mounting frame defining a longitudinal axis;
an input connection and an output connection;
a switching tube extending in the longitudinal direction within said mounting frame between said input connection and said output connection and configured to interrupt an alternating current between said input connection and said output connection;
said input connection, said output connection, and said switching tube being held by said mounting frame; and
said mounting frame including latching means for holding additional insulating parts configured to increase an insulation capacity of said mounting frame.

11. The switch pole according to claim 10, wherein said mounting frame is composed of a mechanically dimensionally stable plastic, and said additional insulating parts are composed of an elastically deformable plastic.

12. The switch pole according to claim 10, wherein said additional insulating parts held in said latching means form a labyrinth structure with said latching means.

13. The switch pole according to claim 10, wherein said latching means are latching grooves.

14. The switch pole according to claim 10, wherein said mounting frame has side walls, and said latching means extend in the longitudinal direction on said side walls.

15. The switch pole according to claim 10, wherein said additional insulating parts have a cross section with a U-profile, at least in parts thereof.

16. The switch pole according to claim 15, wherein said mounting frame is formed with latching grooves and said U-profile has free limbs that are inserted, in the installed state, at an end into said latching grooves.

17. The switch pole according to claim 15, wherein said mounting frame has side walls formed with stop shoulders, and said U-profile has free limbs that rest, in an installed state, on said stop shoulders and outer faces thereof are pressed against inner faces of said side walls, producing a force fit between said additional insulating part and said mounting frame.

18. The switch pole according to claim 10, wherein said additional insulating parts have tubular connecting stubs, at least in places thereof, and said connecting stubs, in an installed state, extend in front of at least one of said input connection and said output connection.
